(19) United States
(12) Patent Application Publication
(10) Pub. No.: US 2012/0194538 A1
(43) Pub. Date: Aug. 2, 2012

(54) METHOD AND APPARATUS FOR HIGHLIGHTING FUNCTIONAL DISPLAY ITEMS

(75) Inventor: Christian Maria Johannes Armand Quaedvlieg, Eindhoven (NL)

(73) Assignee: KONINKLIJKE PHILIPS ELECTRONICS N.V., EINDHOVEN (NL)

(21) Appl. No.: 13/501,165

(22) PCT Filed: Oct. 13, 2010
(86) PCT No.: PCT/IB10/54634

§ 371 Date: Apr. 10, 2012

(30) Foreign Application Priority Data
Oct. 20, 2009 (EP) 09173475.6

(51) Int. Cl. G09G 5/02

(52) U.S. Cl. 345/589

(57) ABSTRACT

A method for highlighting functional display items, the method comprising the steps of: selecting (203) a plurality of functional display items for highlight; highlighting (205) one of the selected plurality of functional display items; highlighting (207), simultaneously, at least one other of the selected plurality of functional display items in at least one of a plurality of directions.

### FIELD OF THE INVENTION

The present invention relates to method and apparatus for highlighting functional display items. In particular, but not exclusively, it relates to highlighting hyperlinks on a screen.

### BACKGROUND OF THE INVENTION

Many techniques have been devised to allow for ease of navigation between a plurality of functional display items so that a particular item can be selected and its associated function carried out. For example in browsing the Internet, techniques have been devised to highlight a hyperlink so that the user can easily navigate the Internet.

In one method, a mouse or cursor keys can be used to move a (jumping) highlight. In this way only a current (active) functional display item (such as a hyperlink) is highlighted. If the current functional display item is a hyperlink and a certain mouse button or confirmation key is pressed, a new web page corresponding to this hyperlink is retrieved.

As the user activates the mouse or the cursor keys to scroll down and across a display in any direction, the next item is highlighted. This may involve the highlight jumping around the screen a lot which can be difficult for the user to follow and hence find again the current highlighted item. In some systems this may seem random as the next item may be positioned spatially at any location on the screen compared to the current highlighted item.

US2001/0017634 tries to solve this problem by allowing non-functional display item to be highlighted, i.e. to permit the focus to be positioned in between hyperlinks. This provides some predictability of which item is going to be highlighted next and therefore assist the user is following it on the screen. However, this increases the amount of interaction required by the user to highlight a desired functional display item.

### SUMMARY OF THE INVENTION

Therefore, it would be desirable to improve predictability in movement of highlights between items while limiting the amount of interaction required by the user.

This is achieved according to a first aspect of the present invention by a method for highlighting functional display items, the method comprising the steps of: selecting a plurality of functional display items for highlight; highlighting one of the selected plurality of functional display items; highlighting, simultaneously, at least one other of the selected plurality of functional display items in at least one of a plurality of directions.

This is also achieved according to a second aspect by apparatus for highlighting functional display items, the apparatus comprising: a selector for selecting a plurality of functional display items for highlight; means for highlighting one of the selected plurality of functional display items; means for highlighting, simultaneously, at least one other of said selected plurality of functional display items in at least one of a plurality of directions.

In this way, the next functional display items are also highlighted providing the user with a clear indication of how the current highlight will move around the screen and hence improve predictability of movement of the current highlight without increasing the amount of interaction required by the user.

In an embodiment, the step of highlighting, simultaneously, at least one other of the selected plurality of functional display items comprises the step of: highlighting, simultaneously, at least one other of the selected plurality of functional display items less prominently than the highlight of the one of the selected plurality of functional display items.

In this way, it is clear to the user which of the highlighted functional display items is the current and hence active highlighted item.

The step of highlighting one other of the selected plurality of functional display items in at least one of a plurality of directions may comprise highlighting at least one other (e.g. one other) of the selected plurality of functional display items in each of the plurality of directions. For example, this may be in each direction indicated by cursor keys or other “compass” directions. The user will then have a clear indication of which cursor key or direction of movement of the cursor on the screen will highlight which “next” functional display items. For example, if all four directions of the cursor keys are used, 5 item highlights are visible, instead of the conventional 1. Thus the user is aware of where the next item selected for highlight is positioned even before using cursor keys or the like.

To improve the visual indication of the other of the selected plurality of functional display items an indicator in the direction of the at least one other highlighted functional display item is displayed which may also indicate the direction from the highlighted one of the selected plurality of functional display items to the at least one other highlighted functional display item. For example an arrow (straight line) from the current active functional display item, to the next functional display item, may be added in an unobtrusive way. Additionally the highlights may be coloured and remote control colour-keys may be used to activate the next functional display item of that colour.

### BRIEF DESCRIPTION OF DRAWINGS

For a more complete understanding of the present invention, reference is now made to the following description taken in conjunction with the accompanying drawings in which:

FIG. 1 is a simplified schematic of apparatus according to an embodiment of the present invention;

FIG. 2 is a flowchart of the method steps according to an embodiment of the present invention; and

FIG. 3 is a typical display screen of an embodiment of the present invention.

### DETAILED DESCRIPTION OF EMBODIMENTS OF THE INVENTION

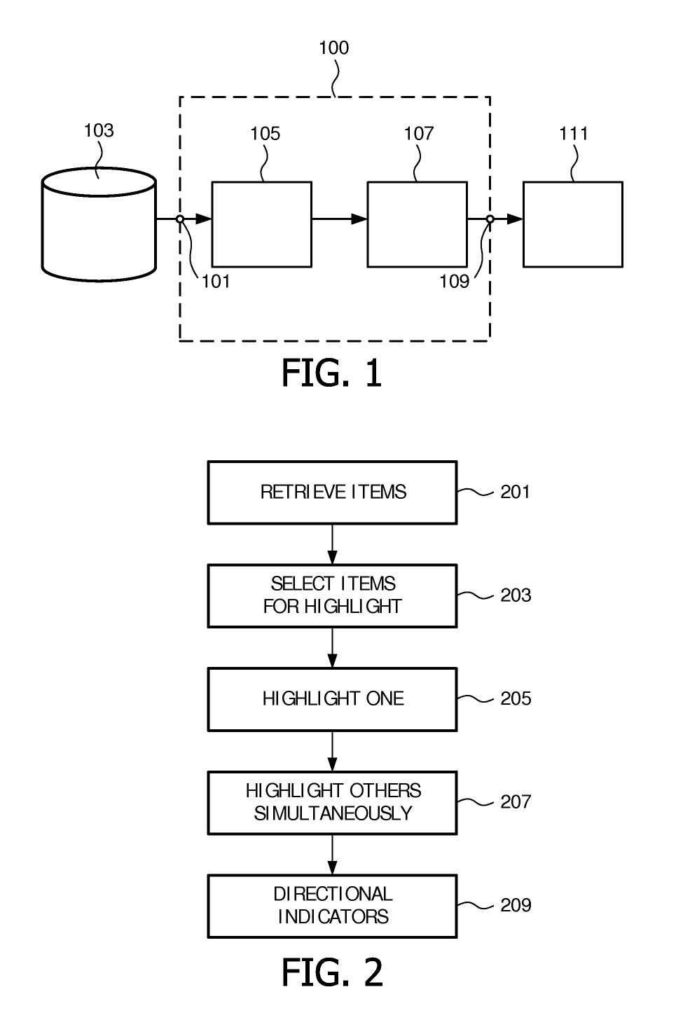

With reference to FIG. 1, apparatus 100 according to an embodiment of the present invention comprises an input terminal 101 connected to a storage device 103. Although the storage means 103 is illustrated here as external to the apparatus 100, in an alternative embodiment, the storage means 103 may be integral with the apparatus. The storage means 103 may be a memory device of a computer system, such as a ROM/RAM drive, HDD, CD, DVD, Blu-Ray, connected to the apparatus 100, or remote server. It may be accessed via a wired or wireless connection and/or accessed via a wider network such as the Internet.

The input terminal 101 is connected to a selector 105. The output of the selector 105 is connected to the input of a driver 107. The output of the driver 107 is connected to an output terminal 109 of the apparatus 100. The output terminal 109 is connected to a display 111. Although the display 111 is illustrated here as external to the apparatus 100, in an alternative embodiment, the display may be integral with the apparatus 100, in an alternative embodiment, the display 111 may be a computer monitor screen, television, projection screen or the like.

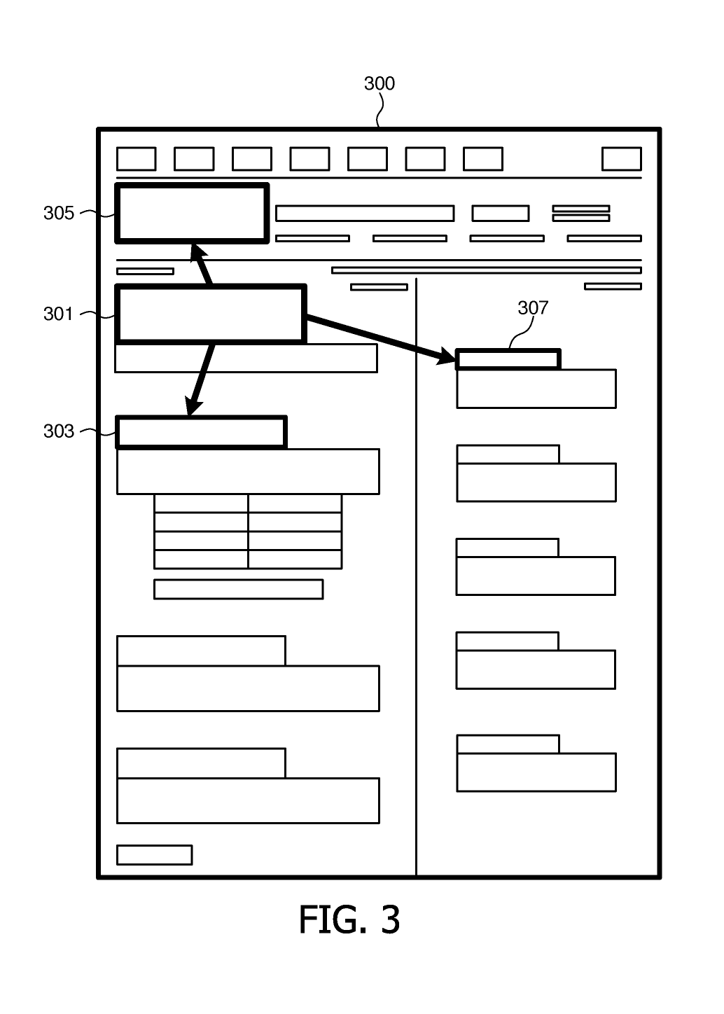

Operation of the apparatus 100 will now be described in more detail with reference to FIGS. 2 and 3.

A plurality of items are retrieved from the storage device 103 for display, step 201. This may be as a result of a search query, for example, on the internet, and a plurality of items, in the form of a list or a plurality of lists, are retrieved and provided on the input terminal 101 of the apparatus 100. The items may include functional display items that have an action associated therewith once selected, for example a hyperlink to a website. These retrieved items are selected for highlight, step 203, by the selector 105. The items may be selected by virtue of the nature of the function associated therewith. For example, for an internet search, the items selected may be the hyperlinks. The function display items may be highlighted in a particular order. This may be based on the next item selected for highlight being that which is spatially next to the current active highlight item or the next item vertically placed in a list format. The number of items selected may vary. In the particular example shown in FIG. 3, 4 functional display items 301, 303, 305, 307 are selected for highlight within a screen 300. This may be achieved by requesting the HTML DOM (document object model) the location (X, Y) and size (width, height) of the next functional display item either the next according to a predetermined order or spatially the next functional display item that the highlight would have jumped to when the user presses either up/down/left/right arrow cursor keys on a keyboard or remote control device.

One of the selected items is the current active functional display item 301 and is highlighted in a more prominent way, step 205, by the driver 107 on the display 111. This may be achieved by use of a bolder overlay or different colour overlay to that of the other highlighted functional items 303, 305, 307 for example. Alternatively the colours of the highlights may correspond to coloured buttons of a remote control device.

In an embodiment, four additional functional display items (for all 4 directions of the cursor keys) may be highlighted, step 207, by the driver 107 on the display 111. This may be further enhanced by use of directional indicators 309, such as arrows for example from the active functional display item 301 to the next functional display items 303, 305, 307. A fourth item for the “left” direction is not displayed here as it is “off screen”.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for highlighting functional display items, the method comprising the steps of:
selecting (203) a plurality of functional display items for highlight;
highlighting (205) one of said selected plurality of functional display items;
highlighting (207), simultaneously, at least one other of said selected plurality of functional display items in at least one of a plurality of directions.

2. A method according to claim 1, wherein the step of highlighting (207), simultaneously, at least one other of said selected plurality of functional display items comprises the step of:
highlighting, simultaneously, at least one other of said selected plurality of functional display items less prominently than the highlight of said one of said selected plurality of functional display items.

3. A method according to claim 1, wherein the step of highlighting (207) one other of said selected plurality of functional display items in any one of a plurality of directions comprises the step of:
highlighting at least one other of said selected plurality of functional display items in each of said plurality of directions.

4. A method according to claim 3, wherein the step of highlighting (207) one other of said selected plurality of functional display items in any one of a plurality of directions comprises the step of:
highlighting one other of said selected plurality of functional display items in each of said plurality of directions.

5. A method according to claim 1 wherein the method further comprises the step of:
displaying (209) an indicator in the direction of the said at least one other highlighted functional display item.

6. A method according to claim 5, wherein the step of displaying (209) an indicator in the direction of the said at least one other highlighted functional display item comprises the step of:
indicating the direction from said highlighted one of said selected plurality of functional display items to said at least one other highlighted functional display item.

7. A method according to claim 6, wherein the step of indicating the direction from said highlighted one of said selected plurality of functional display items to said at least one other highlighted functional display item comprises indicating a direction of a cursor key.

8. computer program product comprising a plurality of program code portions for carrying out the method according to claim 1.

9. Apparatus (100) for highlighting functional display items, the apparatus comprising:
a selector (105) for selecting a plurality of functional display items for highlight;
means (107) for highlighting one of said selected plurality of functional display items;
means (107) for highlighting, simultaneously, at least one other of said selected plurality of functional display items in at least one of a plurality of directions.
